(19) United States
(12) Patent Application Publication
(10) Pub. No.: US 2006/0098087 A1
(43) Pub. Date: May 11, 2006

(54) Housing device for head-worn image recording and method for control of the housing device

(75) Inventors: Thomas Brandt, Starnberg (DE); Stefan Glasauer, Munchen (DE); Erich Schneider, Furstenfeldbruck (DE)

Correspondence Address: HARNESS, DICKEY & PIERCE, P.L.C., P.O. BOX 828, BLOOMFIELD HILLS, MI, 48303, US

(73) Assignee: Ludwig-Maximilians-Universitat, Munchen (DE)

(21) Appl. No.: 10/533,767

(22) PCT Filed: Nov. 6, 2003
(86) PCT No.: PCT/DE03/03671

§ 371 Date: Dec. 6, 2005

(30) Foreign Application Priority Data
Nov. 8, 2002 (DE) 102 51 933.1

(51) Int. Cl. H04N 7/18

(52) U.S. Cl. 348/61

(57) ABSTRACT

In a head-mounted recording device (1), it is suggested that rolling movements (17) of the eyes (8) of the user (4) be used in addition to pitching movements (13) and yawing movements (15) for controlling the viewing field of cameras (12). Using the recording device (1), the biological reflexes for stabilizing the environmental image on the retina are employed for the purpose of stabilizing the image recorded by the cameras (12) in a natural way.

The present invention relates to a recording device for image recording having a recording unit attachable to the head of the user, having a sensor device for recording eye motions of the user, and having an analysis unit connected downstream from the sensor device, which generates control signals that are applied to an actuator acting on the recording unit, through which an image section recorded by the recording unit is movable.

Furthermore, the present invention relates to a method for controlling the alignment of an image section recorded by the head-worn recording unit.

A recording device of this type and a method of this type are known from WO 96/36271. The known device comprises a head support, which may be attached to the head of a user. Cameras are attached to the head support, whose optical axes may be aligned by two-dimensional servo systems in accordance with the position of the eyes. For this purpose, the position of the eyes is detected with the aid of partially reflecting deflection mirrors, which are positioned in front of the eyes and image the eyes of the user on suitable sensors in the reflected wavelength range. The eye position detected with the aid of the sensors is then analyzed and converted into control signals for the servo systems. The optical axes of the camera are tracked on the instantaneous viewing direction of the user by the known device.

The known recording device is suitable above all for monitoring the viewing direction of the user.

A disadvantage of the known recording device and the known method is that no stationary images may be recorded by the camera. Rather, it is necessary to compensate for motions of the head and the external world with the aid of image-processing methods to produce a somewhat stationary image, which may be followed easily by an observer.

On the basis of this related art, the present invention is based on the object of providing a recording device and a method for controlling the recording device, using which stationary images may be recorded easily.

These objects are achieved by the recording device and the method having the features of the independent claims. Advantageous embodiments and refinements are specified in claims dependent thereon.

The recording device is distinguished in that the sensor device completely detects eye movements of at least one eye of the user. Therefore, not only pitching and yawing movements, but rather also the rolling movements of an eye are detected. In this case, the movement of the eye refers to the shifting and rotating of the pupil and the iris of the eye. The recording device thus detects rotational movements of the eyeball around three orthogonal spatial axes. These movements are analyzed by the analysis unit and converted into control signals for a movement of the recording unit which compensates for the head movement. The recording unit is particularly controlled in this case in such a way that the movement of the field of vision of the recording unit follows all components of the eye movement. The recording unit therefore performs not only pitching and yawing movements, but rather also rolling movements. As a result, essentially stationary images are imaged on the image sensor of the recording unit. This is because in the scope of the vestibulo-ocular reflex (VOR), the equilibrium organ in the inner ear of the user assumes the role of a motion sensor, which provides information to the brain on the rotational velocity of the head and on the alignment of the head in relation to gravity. In the brain, the velocity information is converted using an integration procedure into a position signal, which is relayed to the oculomotor nuclei with a reversed sign. This biological reflex results in the eyes always rotating against the head movement, so that the position of the surrounding image imaged on the retina of an eye is stabilized. Therefore, if the rotations of the eyeball around the three spatial axes are detected completely, and if the information obtained in this case is used for the purpose of producing control signals, through which the recording unit is caused to perform a movement that completely follows the eye movement, head movements of the user are compensated for and a largely stable viewing field of the recording unit results, which remains as stationary as the image of the surroundings imaged on the retina. Therefore, image processing methods for subsequent stabilization of the images recorded by the camera, as in the related art, do not have to be used in the recording device.

In a preferred embodiment of the present invention, a device for intrasaccadic suppression is provided in the analysis unit or in the recording unit, which freezes the image recorded by the recording unit in the event of rapid eye movements, the saccades. In this way, smearing of the images recorded by the recording unit in the event of rapid eye movements of the user is avoided.

In a further preferred embodiment, the sensor device comprises an infrared mirror positioned directly in front of the eye and an infrared camera, on which an infrared image of the eyes is imaged. This arrangement allows the user a free, unrestricted field of vision and, simultaneously, complete detection of the eye movements of the user by the sensor device.

In order that the recording units, which are particularly optical cameras, may follow all components of the eye movements, the recording units are preferably mounted so they are rotatable around three spatial axes. In particular, the cameras may be supported by a gimbal suspension.

If the movement of both eyes of the user is detected, important information for a possible autofocus function of the recording unit or the recording units may be obtained from the vergence position of both eyes. This is because the vergence angle of the eyes is a function of the distance to the observed object.

In the following, the present invention will be explained for exemplary purposes on the basis of the attached drawing.

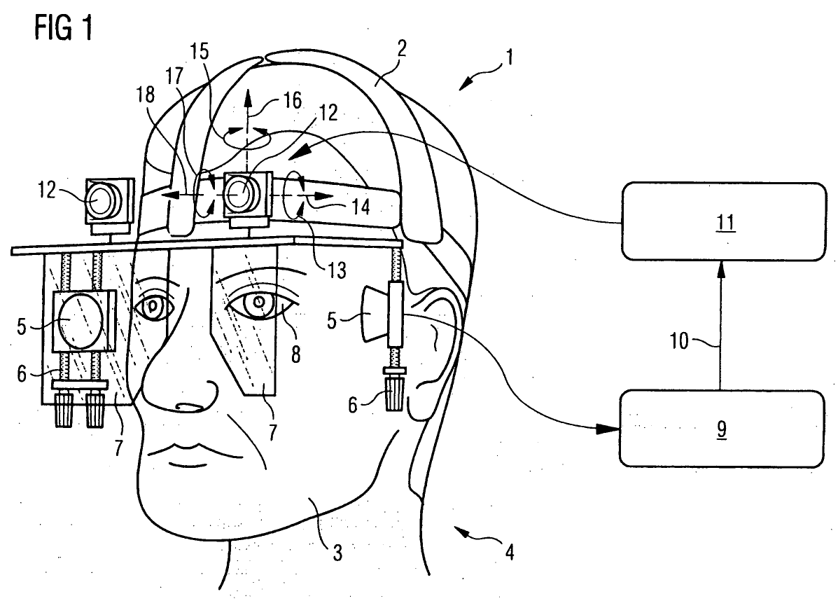

FIG. 1 shows a perspective view of a head-worn recording device; and

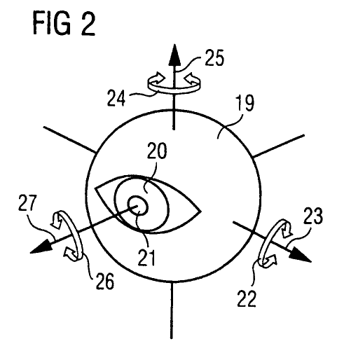

FIG. 2 shows an illustration of the movements executable by an eye.

The recording device 1 illustrated in FIG. 1 comprises a head support 2, which is placed on a head 3 of a user 4. Infrared cameras 5 are attached laterally to the head support 2 at eye height, which are aligned with the aid of an adjustment device 6 in such a way that they each record an image of one of the two eyes 8 via infrared mirrors 7. The infrared mirrors 7 are transparent to visible light, so that the field of vision of the user 4 is not restricted. The movements of the eyes 8, particularly the iris and the pupil, are recorded with the aid of the infrared cameras 5.

The images recorded by the infrared cameras 5 are fed to an analysis unit 9, which determines the components of the movement of the eyes 8. In this case, methods of video oculography known to those skilled in the art are used. These methods, which are known to those skilled in the art, are not subject matter of the present application per se. Control signals 10 are generated and relayed to a motor control 11 on the basis of the components of the movement of the eyes 8 determined by the analysis unit 9. In accordance with the control signals 10, the motor control 11 controls drive motors (not shown in FIG. 1), which move cameras 12 attached to the head support 2 above the eyes 8 of the user 4. The cameras 12 are mounted so they are rotatable around three spatial axes, so that the cameras 12 may follow all components of the movement of the eyes 8. In particular, the cameras 12 are not only capable of executing a pitching movement 13 around the horizontal axis 14 and a yawing movement 15 around the vertical transverse axis 16, but rather also a rolling movement 17 around a longitudinal axis 18, which runs along the optical axis of the camera 12.

The different rotational movements of the eyes 8 are shown enlarged in FIG. 2. An eyeball 19 having an iris 20 and a pupil 21 is schematically illustrated. Through muscles attached to the eyeball 19, the eyeball 19 may execute pitching movements 22 around an essentially horizontal transverse axis 23, yawing movements 24 around a vertical transverse axis 25, and rolling movements 26 around a longitudinal axis 27, the longitudinal axis 27 being the perpendicular to the surface of the eyeball 19 leading through the center of the pupil 21.

Since the movement of the cameras 12 follows the movements of the eyes 8, the images recorded by the cameras 12 are stationary. This is because the unconscious control of the eyes 8 is performed in such a way that the image on the retina is as stationary as possible. Thus, the vestibulo-ocular reflex already noted ensures that the eyes 8 always rotate against the movement of the head 3 so that the image of the surroundings on the retina is stationary. In the scope of the vestibulo-ocular reflex, the equilibrium organ in the inner ear of the user 4 assumes the role of the motion sensor, which provides information to the brain of the user 4 on the rotational velocity of the head 3 and on the alignment of the head 3 in relation to gravity. In the brain of the user 4, the velocity information is converted with the aid of an integration procedure into a position signal, which is in turn relayed with reversed sign to the oculomotor nuclei. As a result, the eyes therefore always rotate against the head movement. Recognizing faces or reading street signs while running is only possible in this way, for example. This vestibulo-ocular reflex is used by the recording device 1 for stabilizing the viewing field of the camera 12, in that the movement of the camera 12 is controlled by the pitching movements 22, yawing movements 24, and rolling movements 26 of the eyes 8 of the user 4.

In addition, still further reflexes contribute to stabilization of the images recorded by the cameras 12. A similar mechanism becomes active, for example, if large-area visual stimuli pass by the user 4. This is the case, for example, if the user 4 looks out the window of a moving train. The brain of the user 4 extracts velocity information from the optical stimuli and relays this to the same oculomotor structures which are also the basis of the vestibulo-ocular reflex. The eyes 8 are controlled against the movement, so that the user 4 obtains a clear image of his environment in spite of the moving train. Since the eyes 8 may not be deflected arbitrarily, the eyes 8 are reset at regular intervals using rapid eye movements, the saccades. This mechanism is referred to as optokinetic nystagmus (OKN), which comprises a sequence of slow compensatory eye movements and rapid restoring movements.

In addition to these involuntary eye movements, the user 4 may also perform voluntary eye movements. These are slow eye tracking movements and rapid viewing jumps, which are also referred to as saccades. The first are used by the user 4 if he follows a flying bird with his eyes, for example. The rapid viewing jumps are used, in contrast, if the eyes 8 are moved back and forth between two speech partners, for example.

In the recording device 1, these complex biological eye movements assume the control of the cameras 12. Movements of the eyes 8, which are used for the purpose of obtaining stable images of the environment and, in addition, for allowing active exploration of this environment, are detected by the infrared cameras 5 and converted into equivalent movements of the cameras 12. It is therefore not necessary to equip the recording device 1 with technical motion sensors and stabilize the image of the cameras 12 with the aid of these sensors, since the natural reflexes of the equilibrium organ described above are exploited to compensate for the movement.

A further biological effect which may be exploited for controlling the recording device 1 is the vergence position of the eyes 8. During binocular observation of objects, the eyes 8 assume an angle as a function of the object distance, as in triangulation, so that each eye 8 may observe the object in the region of highest resolution, the fovea. Important information for a possible autofocus function of the cameras 12 may be calculated from the vergence position, since the vergence angle is a function of the distance to the observed object.

Furthermore, it is possible to execute the image processing performed by the brain of the user 4 correspondingly on the images recorded by the cameras 12. In order to suppress erroneous apparent movements of the environment in the event of rapid movements of the eyes 8, for example, the intrasaccadic suppression system in the brain of the user 4 causes suppression of the movement perception during a saccade. This results in a transsaccadic constancy of the perceived spatial movement.

In order to avoid smearing of the image recorded by the cameras 12 in the event of rapid movements of the eyes 8, a saccadic suppression device may be provided in the analysis unit 9, which is always triggered when a rapid viewing change occurs. The artificial movement suppression may be performed, for example, in that the last image before the saccade is repeated or frozen for the duration of this saccade. The time span in which freezing of the image recorded by the camera 12 is necessary is in the range of 100 ms, as a function of the amplitude of the saccade.

The recording device 1 allows the user 4 to make video recordings even under conditions under which unblurred recordings were not possible until now. In this case, the user 4 may freely move his head 3 and eyes 8, as well as his arms and legs. During the film recording, the user 4 may, for example, run, move in difficult country, or concentrate on controlling a machine or operating a device, without having to worry about recording blurry images. This is because the vestibulo-ocular and optokinetic reflexes ensure a natural stabilization of the image field recorded by the camera 12 during any arbitrary movements of the head 3.

If, in an altered embodiment of the recording device 1, the images recorded by the cameras 12 are projected to the user 4 via a projection device on the infrared mirror 7, additional information about his environment may be overlaid to the user 4 as a function of the type of the camera 12 used and as a function of a possible upstream image processing device. Thus, for example, false color representations with emphasis of specific features of his environment or the representation of thermal images are conceivable. The projection of the images on the infrared meter 7 is preferably performed with the aid of liquid crystal displays.

In addition, the present invention allows an array of further applications.

In the field of film and television, films may be produced which reproduce the actual, subjective view of the user 4 or cameraman. Using the recording device 1, film products may thus be produced whose camera control corresponds to the natural viewing conditions, in contrast to the artificial, directed camera control of typical film products. A new quality of filmic representation in entertainment and documentation thus arises in relation to the film techniques currently typical. This also opens new artistic possibilities in the design of films.

The use of the recording device 1 is not solely restricted to human users 4. Modifying the head support 2 for animals is also conceivable. New possibilities would result in the field of animal films in this case.

In the field of sports reporting, the recording device 1 allows the transmission of unblurred images from the view of an athlete, even of skiers, ski jumpers, or dancers.

In the military field or in the field of border protection, a new type of night-vision devices is conceivable, which projects the thermal image in the direction of the viewing target to the user 4 on the semitransparent infrared mirror 7, with unrestricted field of vision and the highest possible mobility.

In neuroscientific research, the recording device 1 may be used for the purpose of analyzing the exploration behavior in freely mobile subjects or patients. For example, the development of viewing control from child to adult may be investigated with the aid of the recording device 1. Furthermore, disorders in psychiatric, neurological, or ophthalmological illnesses may be analyzed.

Furthermore, it is possible using the recording device 1 to investigate the stimulus-caused viewing control with advertising, in the workplace, or while operating complex devices in experiments in the framework of marketing, ergonomics, or work safety.

It is to be noted that in an altered embodiment of the recording device 1, the sensor device comprises at least one contact lens which may be applied to an eye 8 of the user 4 and is provided with an induction coil, which generates an induction signal displaying the orientation of the induction coil in a magnetic field extending on the eye region of the user 4. For this purpose, the different spatial components of the magnetic field are modulated differently, so that the components of the induction signal originating from the different spatial components of the magnetic field are separated in the induction signal and their relative strengths may be compared to one another. The orientation of the induction coil and therefore the position of the eye 8 may then be concluded from the relative strengths of the components of the induction signal.

Finally, it is to be noted that the recording device 1 may be operated both binocularly, as shown in FIG. 1, and also monocularly, using only one camera 12.

1.-18. (canceled)

19. A recording device for image recording having a recording unit attachable to the head of a user, having a sensor device for detecting eye movements of the user, and having an analysis unit, connected downstream from the sensor unit, which generates control signals that are applied to an actuator acting on the recording unit, through which the image section detected by the recording unit is movable,
wherein the sensor device detects pitching, yawing, and rolling movements of at least one eye of the user and the analysis unit analyzes the detected eye movements and generates control signals therefrom, which cause the actuator to move the image section detected by the recording unit so it follows the detected and analyzed eye movements.

20. The recording device according to claim 19,
wherein the analysis unit analyzes voluntary and involuntary eye movements performed by the user.

21. The recording device according to claim 19,
wherein the analysis unit has an intrasaccadic suppression device, which suppresses reproduction of the images recorded by the recording unit if the velocity of the eye movement of the user exceeds a predefined limiting value.

22. The recording device according to claim 19,
whose sensor device has an infrared mirror positioned in the viewing field of the user and an infrared camera directed toward the mirror area of the infrared mirror.

23. The recording device according to claim 19,
whose sensor device comprises a contact lens provided with induction coils.

24. The recording device according to claim 19,
wherein a projection device is provided for projecting the images recorded by the recording unit in the viewing field of the user.

25. The recording device according to claim 19,
whose recording unit has at least one optical camera.

26. The recording device according to claim 19,
wherein the recording unit has a mount rotatable around three spatial axes.

27. The recording device according to claim 19,
wherein a sensor device is assigned to each eye of the user.

28. The recording device according to claim 27,
wherein the analysis unit analyzes the vergence position of the eyes of the user in order to generate an autofocus signal for the recording unit.

29. The recording device according to claim 27,
wherein a camera, which follows the movements of the respective eye, is assigned to each eye of the user.

30. A method for controlling a recording device,
in which the eye movements of a user wearing the recording device are detected by a sensor device and analyzed by an analysis unit and in which an image section detected by a recording unit is moved with the aid of an actuator acting on the recording unit,
wherein pitching, yawing, and rolling movements of an eye of the user are detected by the sensor device, the detected movements are analyzed by the analysis unit and the image section of the recording unit is moved so it follows the detected and analyzed movements of the eye.

31. The method according to claim 30,
wherein voluntary and involuntary movements of an eye of the user are detected and analyzed.

32. The method according to claim 30,
wherein the display of images recorded with the aid of the recording unit is suppressed in the event of movements whose velocity exceeds a predefined limiting value.

33. The method according to claim 30,
wherein the vergence position of both eyes of the user is analyzed and used for focusing the recording unit.

34. A method for image recording, which comprises adjusting for movement associated with a user, using a recording device comprising:
a recording unit attachable to the head of a user, having a sensor device for detecting eye movements of the user, and having an analysis unit, connected downstream from the sensor unit, which generates control signals that are applied to an actuator acting on the recording unit, through which the image section detected by the recording unit is movable,
wherein the sensor device detects pitching, yawing, and rolling movements of at least one eye of the user and the analysis unit analyzes the detected eye movements and generates control signals therefrom, which cause the actuator to move the image section detected by the recording unit so it follows the detected and analyzed eye movements,
wherein said recording device is used for recording films.

35. A method for image recording, which comprises adjusting for movement associated with a user, using a recording device comprising:
a recording unit attachable to the head of a user, having a sensor device for detecting eye movements of the user, and having an analysis unit, connected downstream from the sensor unit, which generates control signals that are applied to an actuator acting on the recording unit, through which the image section detected by the recording unit is movable,
wherein the sensor device detects pitching, yawing, and rolling movements of at least one eye of the user and the analysis unit analyzes the detected eye movements and generates control signals therefrom, which cause the actuator to move the image section detected by the recording unit so it follows the detected and analyzed eye movements,
wherein said recording device is used as a night-vision device.

36. A method for image recording, which comprises adjusting for movement associated with a user, using a recording device comprising:
a recording unit attachable to the head of a user, having a sensor device for detecting eye movements of the user, and having an analysis unit, connected downstream from the sensor unit, which generates control signals that are applied to an actuator acting on the recording unit, through which the image section detected by the recording unit is movable,
wherein the sensor device detects pitching, yawing, and rolling movements of at least one eye of the user and the analysis unit analyzes the detected eye movements and generates control signals therefrom, which cause the actuator to move the image section detected by the recording unit so it follows the detected and analyzed eye movements,
wherein said recording device is used for monitoring the viewing direction of test subjects.
